(19) United States
(12) Patent Application Publication
(10) Pub. No.: US 2017/0363880 A1
(43) Pub. Date: Dec. 21, 2017

(54) DIRECT LASER WRITING OF 3-D GRATINGS AND DIFFRACTION OPTICS

(71) Applicant: PRESIDENT AND FELLOWS OF HARVARD COLLEGE, Cambridge, MA (US)

(72) Inventors: Eric Mazur, Concord, MA (US); Michael Gerhard Moebius, Cambridge, MA (US); Kevin Vora, Cambridge, MA (US); Seung Yeon Kang, Seoul (KR); Phillip Alejandro Munoz, Cambridge, MA (US); Guoliang Deng, Sichuan (CN)

(21) Appl. No.: 15/532,670

(22) PCT Filed: Dec. 3, 2015
(86) PCT No.: PCT/US2015/063764

§ 371 Date: Jun. 2, 2017

Related U.S. Application Data
(60) Provisional application No. 62/087,097, filed on Dec. 3, 2014.

(51) Int. Cl. G02B 27/44; G02B 5/18; G02B 27/42

(52) U.S. Cl. CPC G02B 27/44; G02B 27/4272; G02B 5/1857; G02B 5/1876

(57) ABSTRACT

Diffractive optical elements and methods for their fabrication are disclosed. In one aspect, a diffractive optical element is disclosed, which comprises a polymeric substrate substantially transparent to at least one electromagnetic radiation wavelength, and a plurality of metallic inclusions distributed in said polymeric substrate according to a predefined pattern such that said inclusions can collectively diffract at least a portion of incident radiation having said at least one radiation wavelength.

### RELATED APPLICATION

The present application claims priority to provisional application entitled “Direct Laser Writing of 3-D Gratings and Diffraction Optics,” having an application No. 62/087,097, which was filed on Dec. 3, 2014 and which is herein incorporated by reference in its entirety.

### BACKGROUND

The present invention relates generally to diffractive optical elements, and more particularly to such diffractive optical elements that include a plurality of metallic structures, e.g., in the form of nanoparticles, distributed in a polymeric matrix according to a predetermined pattern.

Integrated diffractive optics have many applications in beam shaping and control on the micro-scale and are becoming prevalent in cutting-edge macro scale optical elements. Fabrication of such optics using lithography, a conventional method for fabricating diffractive optics, has a number of shortcomings. For example, it is limited by a lack of flexibility in positioning structures in the z-direction.

Accordingly, there is a need for improved diffractive optical elements and methods for their fabrication.

### SUMMARY

In one aspect, the present invention provides diffractive optical elements that includes a two or three-dimensional pattern of metallic structures disposed in a polymeric substrate. In general, the metallic structures can have any desired size, e.g., based on the size of the substrate in which they are formed. By way of example, in some embodiments, the metallic structures can have dimensions (e.g., x. y and z Cartesian dimensions) in a range of about 40 nm to about 5000 nm, e.g., about 40 nm to about 100 nm, though other dimensions may also be utilized.

In some embodiments, the metallic structures are distributed according to a three-dimensional (3-D) pattern within the substrate to generate a 3-D diffraction grating. In some embodiments, the metallic structures are distributed in the polymeric matrix so as to generate a diffractive zone plate.

Applications of diffractive optical elements according to the present teachings span micro- and macro-scale implementations. Integrated, multi-layer micro-scale diffraction optics and 3D gratings could find applications in beam shaping and steering in on-chip devices and micro- to millimeter scale devices where bulk (e.g. curved glass lenses) need to be replaced by flat optics due to space constraints. Compound flat lenses can be used for imaging applications (e.g. in on-chip experiments) and micro-lens arrays can be used to produce an array of foci for applications such as parallel direct laser writing or parallel readout of 3D optical memory. Flat lenses can also be used in conjunction with traditional lenses for applications such as aberration control.

In some embodiments, the metallic structures are distributed within the substrate so as to generate a diffractive lens, e.g., a zone plate. In some embodiments, such diffractive lenses can be used to form compound flat lenses. In some applications, the diffractive lenses according to the present teachings can be used in combination with traditional refractive and/or diffractive lenses.

Zone plates have the opposite chromatic dispersion relative to that of a majority of optical materials (i.e., the focus is closer to the zone plate for longer wavelengths than shorter wavelengths). The dispersion property of zone plates can be used in a variety of applications for controlling aberrations, such as controlling chromatic aberration from a lens exhibiting opposite chromatic aberration relative to a zone plate.

Laser writing provides greater flexibility in terms of alignment and orientation of features in a device that cannot be achieved using layer-by-layer lithography techniques. This could include compound lenses along a diagonal axis (i.e., individual components are not in the horizontal plane).

In one application, diffractive elements according to the present teachings can be used in 3D displays.

In one aspect, a diffractive optical element is disclosed, which comprises a polymeric substrate that is substantially transparent to at least one electromagnetic radiation wavelength, and a plurality of metallic inclusions distributed in the polymeric substrate according to a predefined pattern such that the inclusions (herein also referred to as metallic structures) can collectively diffract at least a portion of incident radiation having said at least one radiation wavelength. In other words, the metal inclusions can scatter the light incident thereon such that the phase relationship between the light scattered by different metal inclusions allows constructive interference of the scattered light so as to provide a diffracted light beam. In some embodiments, the wavelength of incident radiation can be, for example, in a range of about 400 nm to about 5000 nm.

In some embodiments, the metallic inclusions can be distributed within the polymeric substrate according to a two-dimensional pattern. In some embodiments, the metallic inclusions can be distributed within the polymeric substrate according to a three-dimensional pattern, e.g., as an ordered stack of a plurality of two-dimensional layers of predefined patterns of the metallic structures. More generally, the metallic inclusions can be distributed throughout the substrate according to any predefined pattern, including patterns that can be characterized as a plurality of two-dimensional patterns having arbitrary orientations relative to one another.

In some embodiments, the metallic inclusions have at least one dimension in a range of about 40 nm to about 5000 nm, e.g., in a range of about 40 nm to about 100 nm. In some such embodiments, all dimensions of the metallic inclusions (e.g., x, y, and z Cartesian dimensions) are in a range of about 40 nm to about 100 nm. In some embodiments, the metallic structures are spaced from one another by a separation distance in a range of about 5 micrometers to about 40 micrometers. The metallic inclusions can be formed of a variety of different metals. Some examples of suitable metals include, without limitation, silver, gold, and copper.

Further, the polymeric substrate can be formed of a variety of different materials. Some examples of suitable polymeric materials include, without limitation, gelatin, polyacrylic acid (PAA), polyvinyl pyrrolidone (PVP), polyvinyl alcohol (PVA), polyvinylcarbazole (PVK), polymethyl methacrylate (PMMA), and polystyrene (PS).

The metallic structures can have a variety of different forms. By way of example, the metallic structures can be in the form of nanoparticles having maximum sizes less than about 1 micron. In some embodiments, the metallic structures are in the form of rings that are arranged relative to one another to form a diffractive element, e.g., a zone plate.

In some embodiments, the metallic inclusions are configured such that said diffractive element comprises a 3-D diffraction grating. In some embodiments, the metallic inclusions are configured such that the diffractive element comprises a diffractive lens.

In some embodiments, the metal inclusions are configured to impart a desired intensity profile to the light diffracted thereby. By way of example, the metal inclusions can be configured to transform an incident plane wave radiation to a diffracted beam exiting the polymeric substrate with a Gaussian intensity profile.

In another aspect, a method of generating a polymeric diffractive element is disclosed, which comprises providing a mixture of a polymer, a metal precursor and a solvent, wherein said polymer is substantially transparent to at least one electromagnetic radiation wavelength, curing the mixture to generate a cured mixture, and applying a plurality of short laser pulses to a predefined locations of said cured mixture so as to generate a predefined pattern of metal structures within said polymer so as to form a diffractive element capable of diffracting at least a portion of incident radiation having said at least one radiation wavelength.

In some embodiments, the mixture is applied to the substrate prior to the curing step. Some examples of suitable substrates include, without limitation, silicon, silica (quartz or amorphous), glass, a rigid plastic (e.g., acrylic), and a flexible material (e.g., PDMS (polydimethylsiloxane)). Some examples of suitable metal precursors include, without limitation, metal salts, such as AgNO₃, AlClO₄, AgBF₄ and HAuCl₄.

The cured mixture comprises a plurality of metal ions associated with said metal precursor. The application of short laser pulses to the cured mixture, which can be in the form of a film having a thickness in a range of about 0.5 micrometers to about 500 micrometers, can cause the reduction of at least a portion of the metal ions at the predetermined voxels (locations) of the cured mixture to form metal structures in those voxels. In some embodiments, the applied laser pulses have a pulsewidth in a range of about 5 fs to about 1 ps (e.g., in a range of about 100 fs to about 500 fs), a central wavelength in a range of about 500 nm to about 1560 nm, and a pulse energy in a range of about 0.07 nJ to about 50 nJ. The number of pulses applied to each location of the polymeric substrate can be selected based on a particular application, e.g., based on the size and scattering strength of the metallic structures generated in response to application of the pulses. For example, in some embodiments, the number of the applied pulses can vary from 1 to about 1000,000 million (e.g., in a range of 1 to about 100,000, or in a range of 1 to about 10,000, or in a range of 1 to about 1000, or in a range of 1 to about 500).

In a related aspect, an imaging device is disclosed, which comprises a sample, a light source, such as a light emitting diode (LED), generating light for illuminating the sample, a camera (e.g., a CCD), and a diffractive polymeric optical element comprising a polymeric substrate and a plurality of metal structures distributed within the polymeric substrate according to a predefined pattern, where the polymeric substrate is substantially transparent to at least one wavelength of radiation generated by the light source. The polymeric diffractive element is positioned between the sample and the camera to facilitate formation of an image of the sample on the camera. By way of example, the diffractive optical element can be a diffractive lens.

In some embodiments, the sample can be a microfluidic device, though a variety of other samples can also be employed.

In some embodiments, the imaging device further includes another diffractive polymeric optical element that is disposed between the light source and the substrate for condensing light emitted by the light source onto the substrate, where this diffractive polymeric optical element includes a polymeric substrate that is substantially transparent to at least a wavelength of radiation emitted by the light source and a plurality of metal structures that are distributed within the polymeric substrate according to a predefined pattern.

In some embodiments, one or both of the diffractive polymeric optical elements and the sample form an integral structure. In some embodiments, the metal structures of the polymeric diffractive optical elements have at least one dimension in a range of about 40 nm to about 100 nm. In some such embodiments, the metal structure have all dimensions (e.g., x, y, and z Cartesian dimensions) in a range of about 40 nm to about 100 nm.

Further understanding of various aspects of the present teachings can be obtained, for example, by reference to the following detailed description in conjunction with the associated drawings, which are discussed briefly below.

### BRIEF DESCRIPTION OF THE DRAWINGS

FIG. 1A schematically depicts a diffractive element according to an embodiment of the present teachings,

FIG. 1B schematically depicts another diffractive element according to another embodiment of the present teachings,

FIG. 2 is a flow chart depicting various steps in a method according to an embodiment for generating diffractive elements according to the present teachings,

FIG. 3 schematically depicts an apparatus suitable for fabricating diffractive elements according to the present teachings,

FIGS. 4A and 4B schematically depict an imaging device according to an embodiment of the present teachings,

FIG. 5A shows an exemplary diffractive structure in the form of a simple cubic lattice fabricated according to the present teachings,

FIG. 5B shows an exemplary diffractive structure in the form of a body-centered cubic lattice fabricated according to the present teachings,

FIG. 5C depicts an optical image of a single layer of a fabricated simple cubic 3D grating,

FIG. 6 schematically depicts an apparatus employed to measure transmission diffraction patterns of 3D lattice gratings fabricated according to the present teachings,

FIGS. 7A, 7B, and 7C show calculated diffraction patterns for a 4-layer cubic lattice at incident beam angles of 0, 20, 40, respectively, and an incident radiation wavelength of 633 nm,

FIGS. 8A, 8B, and 8C show diffraction patterns for a 10-layer cubic grating at 633 nm and at incident beam angles of 0, 20, and 40 degrees, respectively,

FIG. 9 schematically depicts the determination of the radius of each ring in a zone plate according to the present teachings,

FIG. 10A shows an optical image of a 50-micrometer focal length zone plate fabricated using direct laser writing according to the present teachings,

FIG. 10B shows an optical image of a pinhole formed in gelatin using direct laser writing according to the present teachings,

FIG. 10C shows the image of a focal spot formed by the 50-micrometer focal zone plate shown in FIG. 10A when the zone plate was illuminated by a point source generating radiation at wavelengths of 440-700 nm,

FIG. 10D shows an image formed by the 50-micrometer focal length zone plate shown in FIG. 10A in response to illumination by a compound light emitting diode (LED), which consisted of an array of LEDs,

FIG. 11 schematically depicts wavelength selection using a stack consisting of a zone plate, a pinhole, and a second zone plate, and

FIGS. 12A and 12B depict images of light transmitted through a zone plate-pinhole-zone plate stack illuminated by white light at different separations between the optical elements.

### DETAILED DESCRIPTION

In one aspect, the present teachings provide optical diffractive elements that include a polymeric matrix in which a plurality of metallic structures, e.g., in the form of nanoparticles, are distributed according to a predetermined pattern. Examples of such diffractive elements include, without limitation, 3-D diffraction gratings and diffractive lenses, such as zone plates.

Various terms are used herein consistent with their ordinary meanings in the art. In particular, the term “compound” is used herein consistent with its common meaning in the art to refer to a substance composed of atoms or ions of two or more elements in chemical combination. The atoms or ions can be united by covalent, and/or ionic bonds, or van-der-waals forces. The term “polymer” is used herein consistent with its common meaning in the art to refer to a macromolecule formed by the chemical union of a plurality of repeating units (e.g., 5 or more repeating unit). The term “nanoparticle” is used herein to refer to a material structure whose size in any dimension (e.g., x, y, and z Cartesian dimensions) is less than about 1 micrometer (micron), e.g., less than about 500 nm, or less than about 100 nm, e.g., in a range of about 2 nm to about 20 nm. A nanoparticle can have a variety of geometrical shapes, e.g., spherical, ellipsoidal, etc. The term “nanoparticles” is used as the plural of the term “nanoparticle.”

The terms “chemical reduction” and “reduction” are used herein consistent with the use of these terms in the art to refer to a chemical reaction in which a chemical species decreases its oxidation number, typically by gaining one or more electrons. The term “photoreduction” as used herein refers to a chemical reduction that is mediated by photons.

The term “substantially transparent,” as used herein for describing a material, is intended to mean that the linear absorption coefficient of the material for a radiation wavelength is less than about 25%, and preferably less than about 5%. In other words, radiation having that wavelength can penetrate into the material without much absorption by the material.

The term “focal volume” is used herein consistent with its common meaning in the art to refer to a volume extended axially about a focal plane, a plane at which a focused radiation beam exhibits a minimum beam waist and a maximum intensity, up to a plane at which the beam exhibits a beam waist that is larger than the minimum beam waist by a factor of about \sqrt{2}.

The terms “diffract” and “diffraction” are used herein consistent with their ordinary meaning in the art.

The term “about” as used herein to modify a numerical value denotes a variation of at most+/−5% of that numerical value.

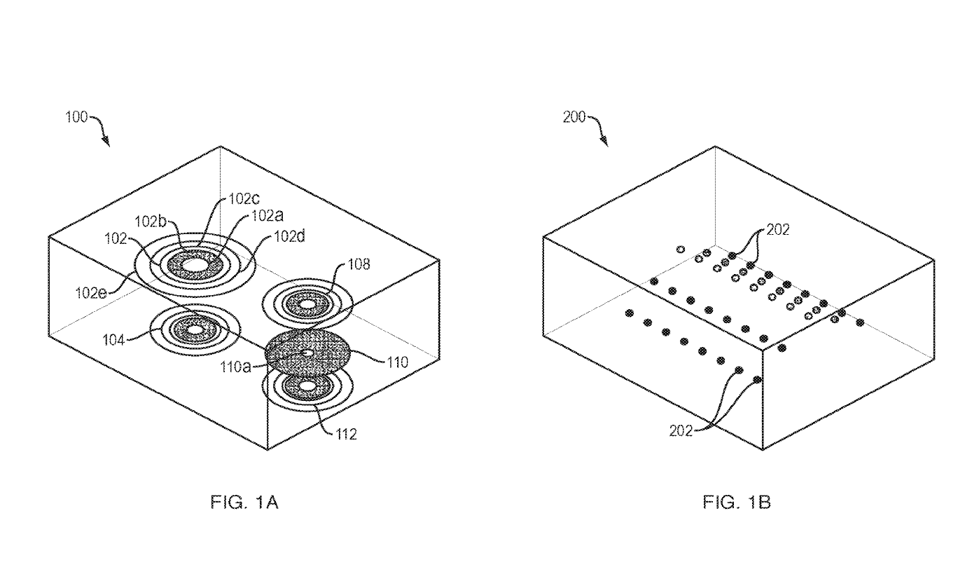

FIG. 1A schematically depicts a polymeric substrate (herein also referred to as a polymeric matrix) 100 in which a plurality of metallic structures (herein also referred to as metallic inclusions) 102, 104, 106, 108, 110, and 112 according to the present teachings are fabricated. Each of the metallic structures 102, 104, 106, 108 and 112 includes a plurality of rings that are concentrically disposed relative to one another so as to provide regions through which electromagnetic radiation penetrating through the polymeric substrate can pass (i.e., regions between the metal rings) and regions that block the electromagnetic radiation (i.e., the metal rings) so as to form a diffractive zone plate. By way of example, the metallic structure 102 includes a plurality of concentric rings 102a, 102b, 102c, 102d, and 102e, which collectively diffract incident light as a zone plate. The metal structure 110 provides a pinhole 110a. As discussed in more detail below, in some embodiments, such a pinhole can be used together with one or more zone plates for selecting a wavelength of incident light comprising a plurality of wavelength (e.g., white light).

In this exemplary embodiment, the polymeric substrate is substantially transparent to incident electromagnetic radiation having one or more vacuum wavelengths in a range of about 400 nm to about 5000 nm. For example, the polymeric substrate can be formed of gelatin, although other polymers such as those listed above can also be employed. Further, in this embodiment, the metallic structures are formed of silver, though other metals such as those listed above can also be employed.

Referring again to the metal structures 102, 104, 106, 108, and 112, the radii of the metal rings, the radial separations between the rings and the widths of the metal rings can be chosen such that the radiation passing through the substantially transparent regions between the rings can constructively interfere at least for one wavelength of radiation to provide a diffractive output beam. Specifically, the transmitted radiation waves from all transparent regions between the rings constructively interfere at the focal point of the zone plate. A single or multiple diffractive orders can be generated as radiation passes through the zone plates.

In some embodiments, the radius of each ring of a zone plate formed according to the present teachings, such as the above zone plates 102, 104, 106, 108, and 112, can be given by the following relation:

$${r}_{n} = \sqrt{n λ f + \frac{{n}^{2} {λ}^{2}}{4}} \qquad Eq . ( 1 )$$

where rₙ is the radius of the n^{th} ring, f is the focal length at wavelength λ. Each radius rₙ defines where the zone plate switches between an opaque and transparent region. For example, the opaque regions can be between n=1-2, n=3-4, etc. or between n=0-1, n=2-3, etc. thus defining the position and width of the opaque and transparent rings.

By way of example, in some embodiments, the radii of the rings can vary in a range of about 1.5 micrometers to about 100 micrometers based on the design wavelength, desired focal length, and number of rings. The minimum separation between two opaque rings, rₙ₊₁−rₙ, can be in the range of about 250 to about 500 nanometers, based on the laser wavelength and numerical aperture of the objective used to focus the laser during fabrication. Further, the radius of a pinhole associated with one of the above metal structures can be, for example, in a range of about 1 micrometer to about 3 micrometers. In some embodiments, the metallic rings of the zone plate can have a thickness (along a direction perpendicular to the plane of the zone plate) in a range of 100 nm to about 500 nm. Diffractive zone plates according to the present teachings can be employed in a variety of different applications, for example, for imaging microfluidic devices, as discussed in more detail below. In some such applications, a camera could be placed at the image plane of the zone plate or additional diffractive or refractive optical elements could be used to magnify the image and project it onto a detector.

By way of another example, FIG. 1B schematically depicts another polymeric substrate 200 according to an embodiment of the present teachings in which a plurality of metal structures 202 are three-dimensionally distributed. Similar to the previous embodiment, the polymeric substrate 200 is substantially transparent to one or more wavelengths in range of about 400 nm to about 5000 nm. The metallic structures 202 are in the form of nanoparticles having a maximum dimension in a range of about 40 nm to about 5000 nm. The metallic structures are distributed according to a predefined three-dimensional (3D) pattern so as to diffract at least one wavelength of electromagnetic radiation incident on the metallic structures 202 as the radiation passes through the polymeric substrate. More specifically, in this embodiment, the metallic structures 202 are distributed throughout the polymeric matrix according to a geometrical pattern such that, for at least one wavelength of incident radiation, the radiation scattered by one metal structure would constructively interfere with radiation scattered by the other metal structures such that the metal structures collectively diffract the radiation out of the polymeric substrate at a specific angle relative to the incident radiation. In general, the diffracted angle will vary with wavelength. In many embodiments, a radiation wavelength that passes through the polymeric substrate will diffract (i.e., constructively interfere) at some angle.

By way of example, the metal structures can be distributed within the polymeric substrate 200 as a stack of a plurality planes in which the nanoparticles are two-dimensionally distributed, where for each two-dimensional distribution each metal structure is separated from an adjacent metal structure by a separation distance in a range of about 250 nm to about 40 micrometers (e.g., in a range of about 5 micrometers to about 40 micrometers). The separation between two adjacent metal structures in two different two-dimensional planes can be, for example, in a range of about 500 nm to about 40 micrometers (e.g., in a range of about 5 micrometers to about 40 micrometers).

More generally, the metallic nanoparticles can be distributed within the polymeric matrix according to any desired pattern so as to obtain a particular diffractive element. By way of example, the metal structures 202 can be configured such that the diffractive element functions as a three-dimensional diffractive grating, or a diffractive lens.

In a method of fabricating diffraction elements according to the present teachings, such as those discussed above, short laser pulses are focused in the bulk of a polymeric matrix containing metal ions, e.g., as a result of dissolving a metal salt in the polymeric matrix, in a plurality of predefined locations so as to cause chemical reduction of the metal ions in voxels within the focal volumes of the pulses, thereby generating metal structures.

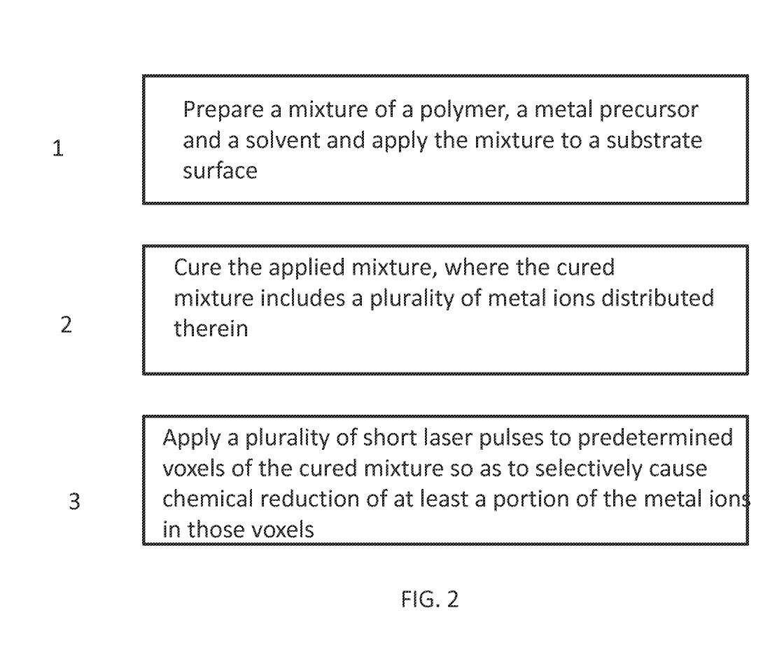

More specifically, with reference to flow chart of FIG. 2, in some embodiments, a mixture of a polymer, a metal precursor, and a solvent is generated and the mixture is applied to a substrate surface (step 1). By way of example, the mixture can be in the form of a solution or a colloid. For example, in some cases the solvent can be water and the mixture can be in the form of an aqueous solution. The mixture can be applied to the substrate surface using a variety of different techniques, such as spin-coating, pouring the mixture onto the substrate's surface or dipping the substrate into the mixture. In some cases, the substrate's surface may be treated, for example, via plasma treatment and/or salinization, prior to application of the mixture thereto. For example, in some embodiments, the substrate's surface can be treated with a silane, such as Acryloxy Propyl Methoxy Silane (APMS) or Mercapto Propyl Trimethoxy Silane. Further, a variety of different substrates can be employed. Some examples of suitable substrates include, without limitation, glass, polymer, and semiconductor substrates (e.g., silicon).

A variety of polymers and metal precursors can be employed. Some suitable examples of polymers include, without limitation, gelatin, polyvinyl pyrrolidone (PVP), polyvinyl alcohol (PVA), polyvinylcarbazole (PVK), polymethylmethacrylate (PMMA), polystyrene (PS), and some examples of suitable metal precursors include, without limitation, a variety of silver salts, such as AgNO₃, AlClO₄, AgBF₄ and gold salts, such as HAuCl₄, among others. Some examples of suitable solvents include, without limitation, water (e.g., distilled water), ethanol, and ethylene glycol. The cured polymer can be in the form of a film having a thickness, e.g., in a range of about 0.5 micrometers to about 500 micrometers.

With continued reference to flow chart of FIG. 2, in some embodiments, the applied mixture can be cured, for example, via heat treatment to form a polymeric layer through which metal ions associated with the metal precursor are distributed (step 2). The curing of the mixture can be achieved, for example, by exposing the mixture to an elevated temperature, e.g., by placing the mixture in an oven, for a selected time. For example, the elevated temperature can be a temperature in a range of about 40° C. to about 150° C., e.g., in a range of about 50° C. to about 100° C. The heating duration can be, for example, in a range of about 30 minutes to about 2 hours.

Following the curing step, a plurality of short laser pulses can be applied to predetermined voxels of the cured mixture so as to selectively cause chemical reduction of at least a portion of the metal ions in those voxels. The applied radiation pulses have a central wavelength to which the polymeric matrix is substantially transparent so that the radiation pulses can penetrate to various desired depths of the polymeric matrix. The pulses are focused in predefined voxels of the substrate so as to have a sufficiently high intensity at those voxels, e.g., an intensity in a range of about 5×10¹³ W/m² to about 10¹⁸ W/m² (and a fluence in a range of about 50 to about 10⁵ J/m² per laser pulse) so as to cause chemical reduction of at least a portion of the metal ions in those voxels. Without being limited by any particular theory, non-linear absorption of the radiation by one or more constituents of the polymeric film (e.g., a moiety of the polymer or the solvent) can cause electronic excitation of the constituent into one or more excited electronic states. An electronic charge transfer between such excited electronic state(s) and the metal ions can cause the chemical reduction of the metal ions to form metal structures at the focal volumes of the laser pulses. The polymeric matrix can be translated along each of the 3 Cartesian coordinates (x,y, and z) to allow fabrication of disconnected metal structures according to a predetermined pattern.

By way of example, the pulsewidths of the applied laser pulses can be in a range of about 5 femtoseconds (fs) to about 100 nanosecond (ns), e.g., in a range of about 5 fs to about 100 picoseconds (ps), or in a range of about 10 fs to about 500 fs. The central wavelength of the applied pulses can be, e.g., in a range of about 500 nanometers (nm) to about 1560 nm, e.g., in a range of about 525 nm to about 1050 nm, such as 800 nm. In some embodiments, the pulses applied to the polymeric matrix can have an energy in a range of about 0.07 nJ to about 50 nJ.

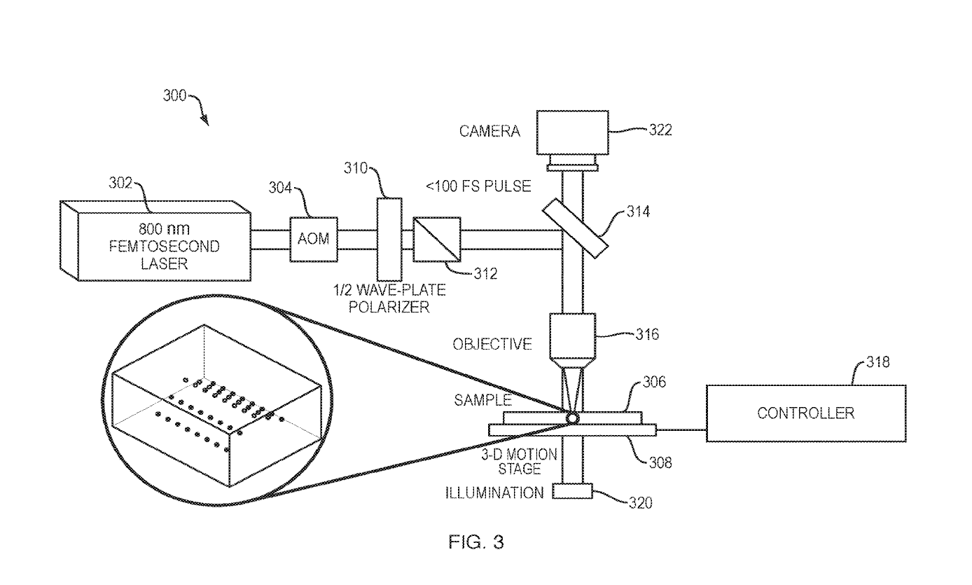

FIG. 3 schematically depicts an exemplary apparatus 300 that is suitable for fabricating diffractive optical elements according to the present teachings, e.g., by using the above steps. The apparatus 300 includes a femtosecond laser system 302 that generates laser pulses having a central wavelength of 80 nm and a pulsewidth of about 100 femtosecond (fs). A acousto-optic modulator (AOM) 304 acts as a fast shutter for selecting as few as a single pulse from a pulse train (e.g., a 10 MHz pulse train in this example) for application to each of a set of predefined voxels (locations) of a sample 306 (a polymeric matrix impregnated with metal ions), which is mounted on a three-dimensional (3-D) motion stage 308. The apparatus 300 further includes a half-wave plate 310 and polarizer 312, which are employed for fine control of the laser power at the sample. After passage through the AOM 304, the half-wave plate 310 and the polarizer 312, the femtosecond laser pulses are reflected by a dichroic mirror 314 toward an objective lens 316. The objective lens 316 focuses the laser pulses inside the sample. A controller 318 can be programmed to move the 3-D stage 308 along three orthogonal direction (e.g., x, y, and z Cartesian coordinates) so as to focus the laser pulses into a predefined set of voxels within the sample, thereby fabricating a plurality of metal structures (e.g., disconnected metal structures) within the sample such that the metal structures can collectively diffract at least one wavelength of incident radiation.

In this embodiment, a light source 320, e.g., a light emitting diode (LED), can illuminate the sample from below with visible radiation. The visible radiation passes through the objective lens, and the mirror 314 and is detected by a camera 322, which forms a visible image of the substrate. Such an image can be used, for example, for alignment of the substrate, alignment of a laser used for fabrication, and/or in-situ inspection of the device during fabrication.

In some embodiments in which the numerical aperture (NA) of the objective lens is about 0.9 metallic, feature sizes of about 80 nm and a spacing of about 500 nm between the metal structures can be achieved. A higher objective numerical aperture can enable fabrication of smaller metal structures as well as more closely-packed structures. For example, in some embodiments, metallic feature sizes as small as 40 nm and feature spacings as low as 250 nm can be achieved.

In some embodiments, rather than using a single objective lens, a micro-lens array (not shown) can be used to focus the laser pulses concurrently into a plurality of voxels within the sample, thereby fabricating in parallel a plurality of metallic structures within the sample.

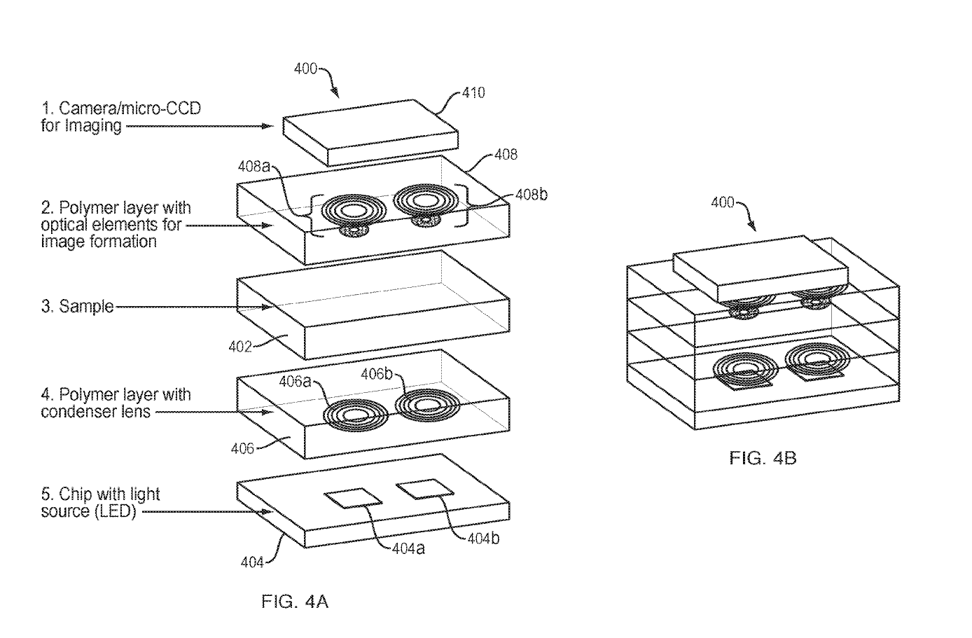

As noted above, a diffractive optical element according to the present teachings can be employed in a variety of different applications. By way of example, FIGS. 4A and 4B schematically depict a device 400 that can include one or more diffractive elements according to the present teachings, which can be used for imaging a sample 402, e.g., an external sample or a portion of the device formed integrally with, or otherwise coupled to, the diffractive element(s). More specifically, in this embodiment, the device 400 includes a semiconductor chip 404 providing a plurality of light emitting diodes (LEDs) 404a and 404b for generating light for illuminating the sample 402.

An optional polymeric diffractive element 406 includes a plurality of metallic diffractive lenses 406a and 406b, formed in accordance with the present teachings, which receive light from the LEDs 404a and 404b, respectively, and function as condenser lenses for illuminating the sample 402. The condenser lenses can improve image resolution, depending on the dimensions and setup of the light sources. In some implementations, one or more laser-fabricated pinhole(s) (not shown) can also be included in the polymeric element 406 to act an aperture(s) for the light source(s).

Another polymeric diffractive element 408 includes diffractive optical elements 408a, 408b, formed in accordance with the present teachings, for forming an image of the illuminated sample on a camera 410, e.g., micro-CCD array.

In some embodiments, the sample can be a polymeric device, e.g., a device formed primarily of PMMA (poly (methyl methacrylate)) or PDMS (polydimethylsiloxane). For example, the sample can be microfluidic device having a plurality of microfluidic channels.

The imaging device 400 can be fabricated in a variety of different ways. The laser-fabricated metal structures can be formed in the polymeric layers either before they are bonded to the sample or after the polymeric layers are added to the sample. This can provide flexibility for custom designing the required optical elements specifically for a sample (e.g., a lab-on-chip/micro-fluidic device) and fabricating the optical elements on the device once assembled or mass-producing polymer films with built-in imaging elements which can be applied to samples for quick imaging.

In some embodiments, one or both polymer diffractive elements 406 and 408 can be integrally formed with the sample 402. Alternatively, the polymeric diffractive elements 406 and 408 can be formed separately from the sample, and bonded to the sample, e.g., by using adhesives, functionalization of the surfaces of the sample and polymer layer with diffractive elements, or plasma treatment of the sample and polymer layer containing the diffractive elements.

For example, a mixture of a polymer, a metal precursor, and a solvent can be applied to a surface of the sample (e.g., an on-chip device, such as a microfluidic device), followed by curing the mixture and applying a plurality of short laser pulses to pre-determined voxels of the cured mixture in a manner discussed above to form the diffractive metallic structures within the cured polymeric mixture. Alternatively, a cured polymeric layer having metal ions distributed therein, such as those discussed above, can be applied to a surface of the sample, followed by applying short laser pulses to pre-determined voxels of the cured polymeric layer to form desired diffractive metallic structures therein. In another methods, a diffractive polymeric element having diffractive metallic structures formed within a polymeric matrix can be fabricated on a separate substrate, in a manner discussed above, and be subsequently be bonded to the sample. In yet another method, a metal precursor can be incorporated into a polymer-based device (e.g., a microfluidic device) and the laser fabrication of the metallic structures can be performed, in a manner discussed above, directly in the polymer-based device to form a monolithic device with no need to bond different polymeric substrates to one another.

Because direct laser writing according to the present teachings is a mask-less fabrication technique, dimensions of the elements can be changed on the fly during fabrication. For example, if any of the dimensions (i.e., width, length or thickness) of the sample or any polymeric layer is different from the original specification, the dimensions of the diffractive elements and their positions can be changed to adjust the focal length, magnification or field-of-view. This can allow for greater compensation of fabrication variations and can lead to more flexible design specifications.

In another aspect, the metallic diffractive structures can be designed to control the intensity profile and/or direction of transmitted radiation. In particular, the diffractive structures (elements) can be defined as structures that modulate the amplitude and/or phase of incident radiation in order to control the profile and/or direction of the transmitted light. Diffractive elements can either be binary or analog. Binary elements modulate the amplitude or phase of incident light by a fixed value. For example, a binary amplitude modulator would ideally have regions with 100% transmission and regions with 0% transmission. Analog elements have graded regions which apply variable amounts of amplitude or phase modulation.

The direct laser writing fabrication methods according to the present teachings can be used to provide amplitude modification. Regions with metal structures exhibit lower transmission than unaltered polymer regions. The laser exposure dose determines the opacity of metal structures produced and thus the amplitude of transmission. This allows the production of binary and analog diffractive elements, based on the variations in laser exposure parameters. Based on the refractive index changes in the laser-exposed regions due to modifications in the polymer matrix and metal structure formation, phase difference can be incorporated into the design diffractive elements.

Computational methods can be used to design diffractive elements that provide specific transmission profiles. In the case of focusing elements, these methods can be used to control the type of beam that is transmitted, for example, a Gaussian or Bessel beam. The same computational methods can be used for different applications as well, such as designing beam splitters, among others.

By way of example, one computational design method is the Fourier transform method. There are two ways to use this method. In one case, the process can start with a known transmission pattern through a known diffractive element design. Fourier transforms can be used to calculate the resulting propagation of light to an observer plane. Alternatively, the process can start with a desired transmission pattern at the observer plane. A Fourier transform is used to calculate the transmission pattern through a diffractive element that would produce the desired field profile at the observer plane. The transmission pattern can then be achieved by adjusting the exposure dose applied to the polymer for generating the metal structures.

A second computational design method is based on point sources. The diffractive element is broken up into an array of point sources of light. The resulting propagation of light from each of these point sources is calculated at an observer plane. By superimposing the resulting patterns from all points in the array, the resulting light distribution can be calculated. Based on the required light intensity emitted from each point in the array to produce the desired light propagation, the amplitude and/or phase modulation at each point in the diffractive element can be determined. This corresponds to a specific amount of metal structure growth and material modification at each point within the diffractive element, thus determining the laser exposure dose required.

Both methods require iteration to arrive at the optimal diffractive element design to produce the desired output. Adaptations of these methods can be used for 3D diffractive optical elements.

The following examples are provided for only for illustrative purposes and for further elucidation of various aspects of the present teachings, are not provided to present necessarily the optimal ways of practicing the invention or optimal results that can be obtained.

### Example 1

Samples were fabricated in a single step by focusing an ultrafast laser with 70-fs pulses at 11-MHz repetition rate centered at 795 nm into a thick (100-250 μm) polymer film (gelatin) doped with silver nitrate. The apparatus shown in FIG. 3 and described above was utilized for direct laser writing of patterns of metallic structures in the polymeric matrix so as to fabricate optical diffractive elements. The applied pulses cause multi-photon absorption at the focal volume, which in turn prompts reduction of metal ions and formation of silver structures at the focal point. By using a long-travel, high precision 3D translation stage, acousto-optic modulator, and adjusting exposure time and average laser power, shape and size of fabricated features can be controlled. Using a 0.8-NA, long working distance objective, feature sizes below 100 nm and resolution of 0.5 μm were obtained. The polymer was left in place after fabrication, providing a dielectric matrix transparent in the visible and near infrared wavelengths for disconnected structures.

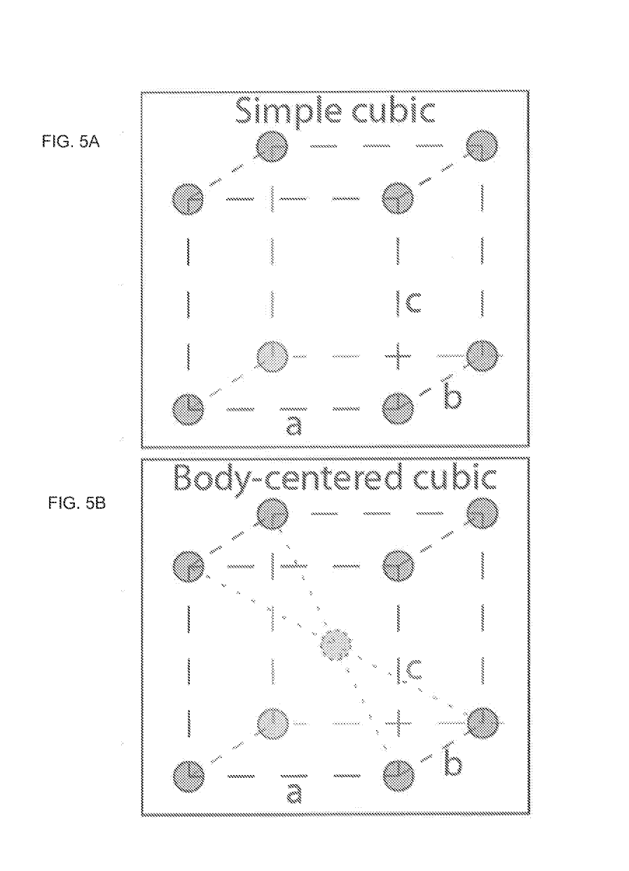

As a demonstration of some aspects of the present teachings, analogs of a number of atomic crystal lattices, such as simple cubic and body-centered cubic lattices (shown schematically in FIGS. 5A and 5B) were fabricated using an exposure of 5-50 mW for 0.1-1 ms. The “atomic spacing” (i.e., the spacing between adjacent metallic structures (scatterers)) was in a range of about 5 micrometers (microns) to about 40 microns in order to observe multiple diffraction orders using visible wavelength illumination. The size of each metallic structure along each Cartesian coordinate (x, y, and z) was in a range of about 0.5 microns to about 2.5 microns. FIG. 5C depicts an optical image of a single layer of a fabricated simple cubic 3D grating.

Different scattering strengths can be achieved by fabricating different sized scatterers by varying the laser exposure parameters. By way of example, metallic scatterers can be spaced by 5-40 μm in order to observe multiple diffraction orders using visible wavelength illumination. The metal lattices can be viewed as comprising a plurality of two-dimensional layers stacked on top of one another to form the three-dimensional lattice. Each two-dimensional layer includes a plurality of metal structures formed according to the present teachings based on a predetermined pattern. In some embodiments, up to 20 such layers can be stacked on top of one another to form the three-dimensional lattice.

Samples spanned several mm in plane and consisted of 2-20 layers in the z-direction. Diffraction patterns were measured in transmission using a 633-nm HeNe laser. Laue diffraction patterns are calculated for comparison with theory.

These analog structures allow visualization of transmission diffraction patterns using visible light, which are comparable to transmission electron diffraction in atomic lattices.

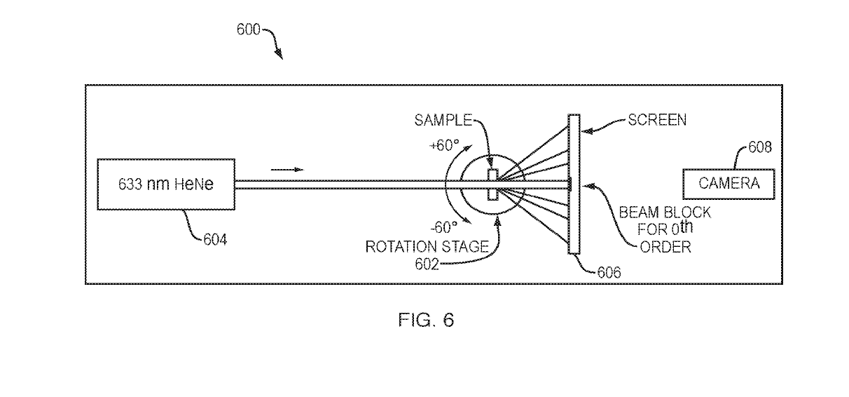

The apparatus 600 shown in FIG. 6 was employed to measure the transmission diffraction patterns of the 3D lattice gratings. As shown schematically in FIG. 6, the sample was placed on a rotation stage 602 such that the sample was located on the axis of rotation. This allowed measuring diffraction through the sample at various angles without translating the sample. A 633-nm HeNe laser 604 was used to illuminate the sample. The beam was collimated and adjusted to 0.7 mm diameter using a telescope (not shown). Transmitted light illuminated a screen 606. A beam block for the 0^{th} order transmitted beam prevented this bright transmitted spot from saturating a camera 608, which was used to image the screen from the back. Scattered light from the source was minimized with an enclosure around the sample, rotation stage, screen, and camera. Diffraction was measured for light incidence angles between −60 to 60-degrees.

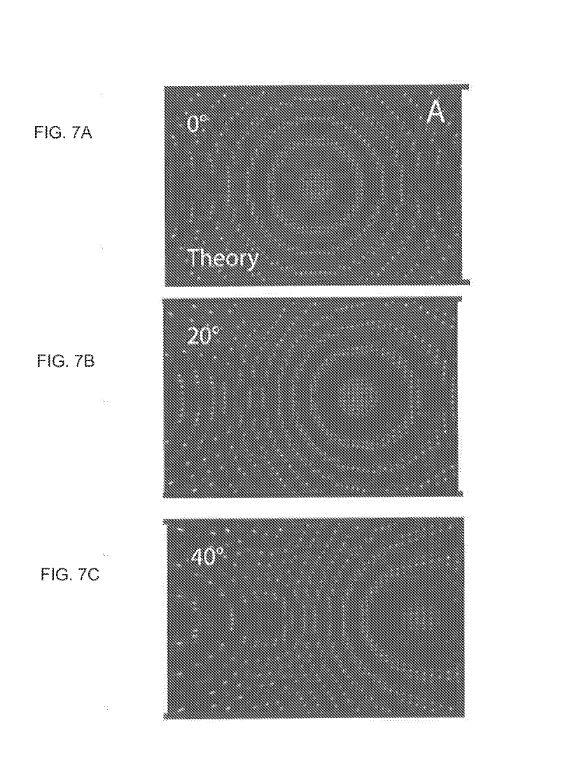

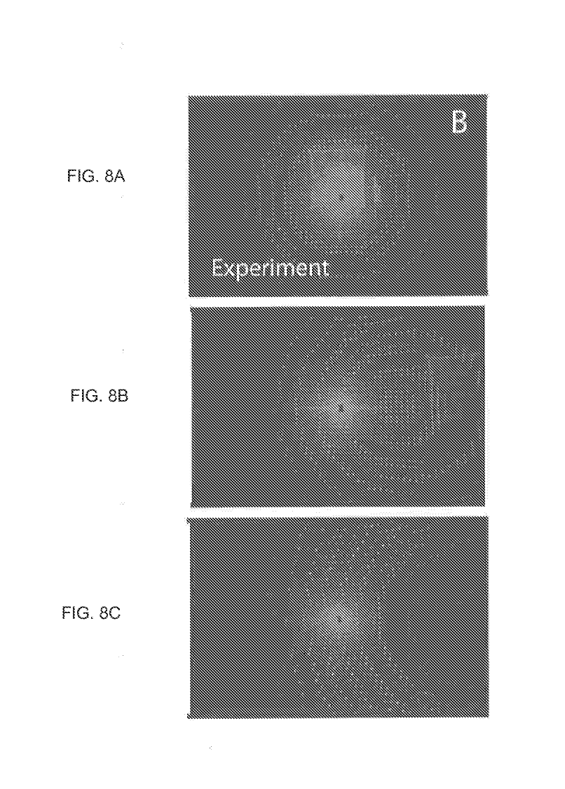

Experimental results from 3D diffraction gratings were in good agreement with Laue theory. FIGS. 7A, 7B, and 7C show calculated diffraction patterns for a 4-layer cubic lattice at incident beam angles of 0, 20, and 40 degrees, respectively. FIGS. 8A, 8B, and 8C show diffraction patterns for a 10-layer cubic grating at 633 nm at incident beam angles of 0, 20, and 40 degrees. Locations of measured diffraction maxima and intensity variations follow those obtained by calculation. Analogs of crystals with a two-atom basis with a strong and weak scatterer exhibit the expected intensity variations. However, bands from each diffraction order are wider than that predicted for a number of layers in the beam direction and weak signals were visible in some forbidden reciprocal lattice points

In one aspect, the present invention provides diffractive lenses, e.g., zone plates, which include a plurality of metal structures distributed according to a predetermined pattern within a polymeric matrix. The diffractive lenses were fabricated using the methods discussed above by direct laser writing into a polymeric matrix.

### Example 2

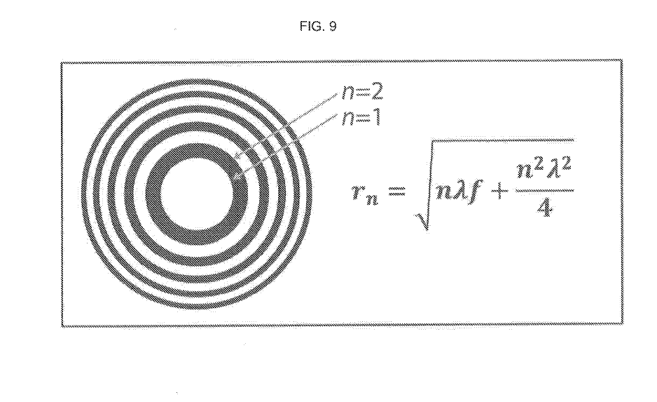

Zone plates were designed as alternating dark and light regions (rings). For each zone plate, the radius of each ring was determined using the above Equation (1), as schematically illustrated in FIG. 9.

The fabricated zone plates were tested using a transmission microscope. Two lasers were used for fabrication of structures, an 80-MHz repetition rate laser centered at 780 nm with 90-fs pulses and an 11-MHz repetition rate laser centered at 795 nm with 60-fs pulses. Other laser wavelengths may also be used as long as linear absorption within the polymer is sufficiently low. Fabrication parameters for these samples depend on the depth of the samples within the polymer matrix. Average power varied from approximately 4-30 mW for features fabricated 0-200 micrometers below the surface of the polymer layer, with higher laser power required for formation of metal structures deeper in the polymer. The stage translation speed during laser exposure varied from 5-30 micrometers/s.

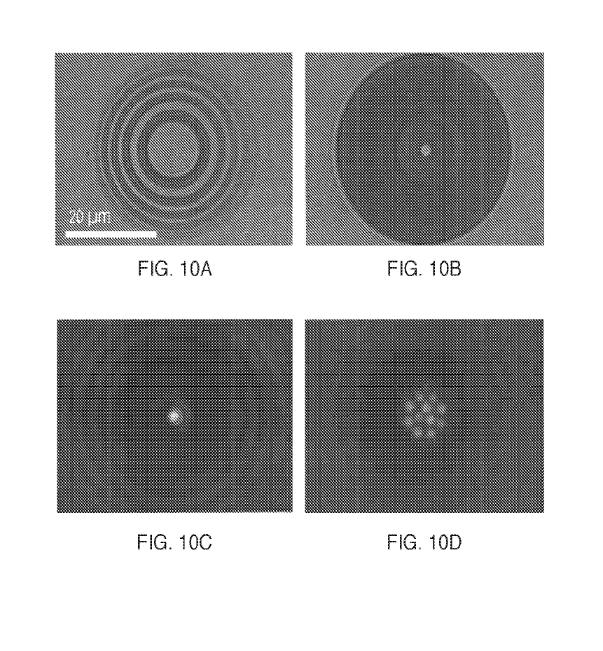

FIG. 10A shows an optical image of a 50-micrometer focal length zone plate fabricated using direct laser writing according to the present teachings using an 80 MHz repetition rate laser centered at 780 nm with 80 fs pulse duration. FIG. 10B shows an optical image of a pinhole formed in gelatin using direct laser writing according to the present teachings. The pinhole was formed by scanning the laser across the polymer (80 fs pulses at a repetition rate of 80 MHz centered at 780 nm) to expose all regions except for the pinhole aperture to sufficient laser irradiation to form opaque silver structures. FIG. 10C shows the image of a focal spot formed by the 50-micrometer focal zone plate shown in FIG. 10A when the zone plate was illuminated by a point source generating radiation at wavelengths of 440-700 nm. And FIG. 10D shows an image formed by the 50-micrometer focal length zone plate shown in FIG. 10A in response to illumination by a compound light emitting diode (LED), which consisted of an array of LEDs. The zone plate formed an image of the array at its focal point, which was captured using a microscope operating in transmission mode.

By shifting the focal plane of an objective lens placed above a zone plate fabricated according to the present teachings, the focal points of the zone plate for various wavelengths of incident light were imaged. The transmitted spectrum of the zone plate can be measured by focusing the transmitted light from a camera port on the microscope into a spectrometer (or into a fiber connected to a spectrometer). In this approach, it is important to block out background light in order to improve the signal to noise ratio.

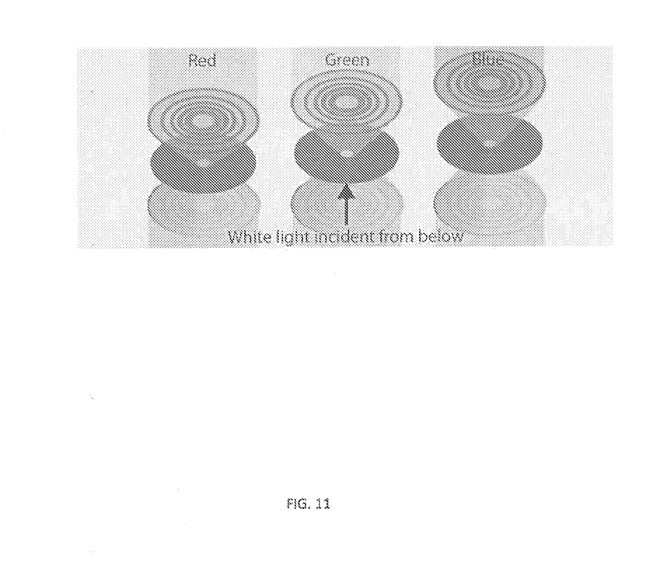

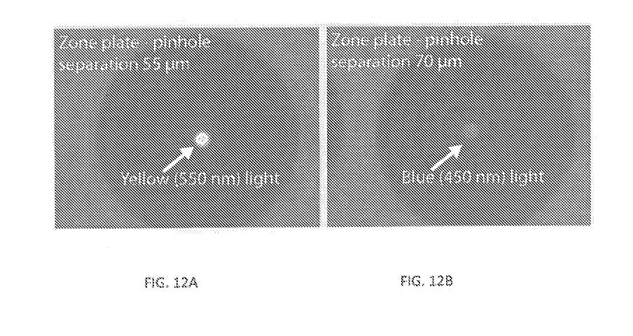

The addition of a laser-written pinhole above a zone plate can enhance wavelength selectivity at the focal point. In some embodiments, a stacked combination of a zone plate and a pinhole can be used for such wavelength selection. FIG. 11 schematically depicts wavelength selection using a stack consisting of a zone plate, a pinhole, and a second zone plate. White light is incident on the stack from below. The bottom zone plate focuses incident light. The distance of the bottom zone plate to the pinhole determines which wavelength of light is focused through the pinhole aperture. Since the zone plate exhibits a shorter focal length for longer wavelengths of incident radiation, the closer the pinhole is to the bottom wavelength the longer is the wavelength of light selected by the pinhole. The second zone plate placed above the pinhole can collimate the radiation transmitted through the pinhole. FIGS. 12A and 12B depict images of light transmitted through a zone plate-pinhole-zone plate stack illuminated by white light at different separations between the optical elements. In FIG. 12A, the pinhole was positioned relative to the bottom zone plate at a separation distance of about 55 micrometers so as to allow the selection of yellow light, while in FIG. 12B the pinhole was positioned relative to the bottom zone plate at a separation distance of about 70 micrometers so as to allow the selection of blue light.

Laser fabricated zone plates exhibited lower signal-to-noise than lithography fabricated zone plates, however, optimization of the laser writing parameters can greatly increase their efficiency. Slow write speeds (10-15 μm/s) at moderate to low laser power (6 mW) provided the cleanest features and best zone plate efficiency.

Those having ordinary skill in the art will appreciate that various changes can be made to the embodiments described above without departing from the scope of the invention.

1. A diffractive optical element, comprising:
a polymeric substrate substantially transparent to at least one electromagnetic radiation wavelength,
a plurality of metallic inclusions distributed in said polymeric substrate according to a predefined pattern such that said inclusions can collectively diffract at least a portion of incident radiation having said at least one radiation wavelength.

2. The diffractive optical element of claim 1, wherein said metallic inclusions are distributed within the polymeric substrate according to a two-dimensional pattern.

3. The diffractive optical element of claim 1, wherein said metallic inclusions are distributed within the polymeric substrate according to a three-dimensional pattern.

4. The diffractive optical element of claim 1, wherein said metallic inclusions are distributed within the polymeric substrate as a stack of a plurality of two-dimensional patterns.

5. The diffractive optical element of claim 1, wherein said metallic inclusions have at least one dimension in a range of about 40 nm to about 5000 nm.

6. The diffractive optical element of claim 5, wherein said metallic inclusions have at least one dimension in a range of about 40 nm to about 100 nm.

7. The diffractive optical element of claim 1, wherein said metallic inclusions are spaced from one another by a separation distance in a range of about 250 nanometers to about 40 micrometers.

8. The diffractive optical element of claim 1, wherein said metallic inclusions are configured such that said diffractive element comprises a zone plate.

9. The diffractive optical element of claim 1, wherein said metallic inclusions are configured such that said diffractive element comprises a 3-D diffraction grating.

10. The diffractive optical element of claim 1, wherein said metallic inclusions are configured such that said diffractive element comprises a diffractive lens.

11. The diffractive optical element of claim 1, wherein said at least one wavelength is in a range of about 400 nm to about 5000 nm.

12. The diffractive optical element of claim 1, wherein said metal inclusions are configured to impart a desired intensity profile to the light diffracted thereby.

13. The diffractive optical element of claim 12, wherein said desired intensity provide is a Gaussian profile.

14. The diffractive optical element of claim 1, wherein said metal inclusions comprise any of silver, gold, and copper.

15. The diffractive optical element of claim 1, wherein said polymeric substrate comprises any of gelatin, polyacrylic acid (PAA), polyvinyl pyrrolidone (PVP), polyvinyl alcohol (PVA), polyvinylcarbazole (PVK), polymethyl methacrylate (PMMA), and polystyrene (PS).

16. A method of generating a polymeric diffractive element, comprising:
providing a mixture of a polymer, a metal precursor and a solvent, wherein said polymer is substantially transparent to at least one electromagnetic radiation wavelength,
curing the mixture to generate a cured mixture,
applying a plurality of short laser pulses to a predefined locations of said cured mixture so as to generate a predefined pattern of metal structures within said polymer so as to form a diffractive element capable of diffracting at least a portion of incident radiation having said at least one radiation wavelength.

17. The method of claim 16, further comprising applying said mixture to a substrate prior to said curing step.

18. The method of claim 17, wherein said substrate comprises any of silicon, silica, glass, and a rigid plastic.

19. The method of claim 16, wherein said cured mixture comprises a plurality of metal ions associated with said metal precursor.

20. The method of claim 19, wherein said applied short laser pulses cause reduction of at least a portion of said metal ions at said predetermined locations of the cured mixture so as to form said metal structures.

21.-36. (canceled)
